(19) United States
(12) Patent Application Publication
(10) Pub. No.: US 2016/0313762 A1
(43) Pub. Date: Oct. 27, 2016

(54) FLEXIBLE DISPLAY PANEL AND METHOD OF MANUFACTURING THE SAME

(71) Applicant: Samsung Display Co., Ltd., Yongin-si (KR)

(72) Inventors: Sun Ho Kim, Yongin-si (KR); Bo Ik Park, Yongin-si (KR); Ju Chan Park, Yongin-si (KR); Hyun Woo Koo, Yongin-si (KR); Tae Woong Kim, Yongin-si (KR)

(21) Appl. No.: 15/133,019

(22) Filed: Apr. 19, 2016

(30) Foreign Application Priority Data
Apr. 22, 2015 (KR) 10-2015-0056662

(51) Int. Cl. G06F 1/16; B32B 37/12; B32B 7/12; G02B 5/30; G02B 1/14

(52) U.S. Cl. CPC G06F 1/1601; G02B 5/3033; G02B 1/14; B32B 7/12; B32B 37/12; B32B 2457/20; B32B 2307/546; B32B 2307/42; G06F 2200/161

(57) ABSTRACT

A flexible display panel and a method of manufacturing the same are disclosed. In one aspect, the flexible display panel includes a flexible substrate configured to display an image. The display also includes a first layer formed over a first surface of the flexible substrate and configured to compress horizontally with a compressive strain force. The display further includes an adhesive interposed between the flexible substrate and the first layer.

### INCORPORATION BY REFERENCE TO ANY PRIORITY APPLICATIONS

This application claims priority to and the benefit of Korean Patent Application No. 10-2015-0056662, filed on Apr. 22, 2015, in the Korean Intellectual Property Office, the entire content of which is incorporated herein by reference in its entirety.

### BACKGROUND

1. Field

The described technology generally relates to a flexible display panel and a method of manufacturing the same.

2. Description of the Related Technology

A display device includes a liquid crystal display (LCD), a plasma display panel (PDP), a field emission display (FED), an organic light-emitting diode (OLED) display, an electrophoretic display (EPD), and the like.

In recent years, research has focused on flexible display devices that can maintain high quality display performance. However, defects in display performance can occur if the display panel bends excessively.

A flexible display can include thin film layers and electrical devices formed on a flexible substrate. When the flexible display bends, strain from the bending is transferred to the thin film layers and the electrical devices, thereby causing cracks in the layers or damaging the electrical devices.

Naturally, such problems are not desired and can cause reduced lifespan and reliability of the flexible display.

### SUMMARY OF CERTAIN INVENTIVE ASPECTS

One inventive aspect relates to a flexible display panel and a method of manufacturing thereof, reducing crack occurrence due to a bending phenomenon by adjusting strain of the flexible display panel which displays images and increasing flexibility scope of the flexible display panel.

Another aspect is a flexible display panel including a flexible substrate for displaying an image and a first layer formed on a first surface of the flexible substrate and having a compressive strain.

In an embodiment, the flexible display panel further includes an adhesive formed between the flexible substrate and the first layer and attaching the first layer to the first surface of the flexible substrate.

In an embodiment, the flexible display panel further includes a polarizing film formed on a second surface of the flexible substrate.

In an embodiment, the flexible display panel further includes a protective film formed on the first surface of the flexible substrate and blocking moisture transmission. The first layer can be formed between the flexible substrate and the protective film.

In an embodiment, the flexible substrate has a portion of the first surface that is folded or bends in a direction facing a remaining portion of the first surface.

Another aspect is a method for manufacturing a flexible display panel that includes forming a first layer, coating an adhesive on one surface of the first layer and providing on the adhesive a flexible substrate having a first surface and a second surface, the first surface and the second surface facing each other. The first layer can have a compressive strain.

In an embodiment, the method further includes providing a polarizing film on the second surface of the flexible substrate.

In an embodiment, the first layer is attached to the first surface of the flexible substrate by the adhesive in a tensioned state by a tensile force.

In an embodiment, the first layer is attached to the first surface of the flexible substrate by the adhesive in a heated and expanded state.

In an embodiment, the flexible substrate displays an image through the first surface of the flexible substrate.

In an embodiment, the flexible substrate has a portion of the first surface that is folded or bends in a direction facing a remaining portion of the first surface.

Another aspect is a flexible display panel, comprising: a flexible substrate configured to display an image; a first layer formed over a first surface of the flexible substrate and configured to compress horizontally with a compressive strain force; and an adhesive interposed between the flexible substrate and the first layer.

In the above flexible display panel, the adhesive is configured to attach the first layer to the first surface of the flexible substrate.

The above flexible display panel further comprises a polarizing film formed over a second surface of the flexible substrate.

In the above flexible display panel, the flexible substrate and first layer are further configured to bend towards the polarizing film.

In the above flexible display panel, the thicknesses of the flexible substrate and the first layer are substantially the same.

The above flexible display panel further comprises a protective film formed over the first surface of the flexible substrate and configured to block moisture transmission, wherein the first layer is interposed between the flexible substrate and the protective film.

In the above flexible display panel, the flexible substrate has a portion of the first surface folded or bent in a direction facing the remaining portion of the first surface.

Another aspect is a method for manufacturing a flexible display panel comprising: forming a first layer; coating an adhesive on a first surface of the first layer; and providing a flexible substrate having first and second surfaces on the adhesive, wherein the first surface and the second surface facing each other, wherein the first layer is configured to compress horizontally with a compressive strain force.

The above method further comprises providing a polarizing film on the second surface of the flexible substrate.

In the above method, the adhesive is configured to attach the first layer to the first surface of the flexible substrate using a tensile force.

In the above method, the adhesive is configured to attach the first layer to the first surface of the flexible substrate in a heated and expanded state.

In the above method, the flexible substrate is configured to display an image through the first surface of the flexible substrate.

In the above method, the flexible substrate has a portion of the first surface that is folded or bent in a direction extending towards the remaining portion of the first surface.

The above method further comprises stretching the first layer such that the stretched first layer has a predetermined tensile force.

In the above method, the tensile force and the compressive strain force extend in opposite directions.

The above method further comprises heating the first layer such that the first layer expands, before coating the adhesive on the first surface of the first layer.

Another aspect is a flexible display panel, comprising: a flexible substrate configured to display an image; a first layer formed over a first surface of the flexible substrate and configured to compress horizontally; a protective film formed over the first surface of the flexible substrate and configured to block moisture transmission; a first adhesive layer interposed between the protective film and the first layer; and a second adhesive layer interposed between the first layer and the flexible substrate.

In the above flexible display panel, the flexible substrate has a substantially uniform thickness throughout the flexible display panel, wherein the first layer has a substantially uniform thickness throughout the flexible display panel.

In the above flexible display panel, the flexible substrate and first layer are further configured to bend towards the polarizing film.

The above flexible display panel further comprises a polarizing film formed over a second surface of the flexible substrate, wherein the first and second surfaces of the flexible substrate oppose each other.

Another aspect is a flexible display panel, comprising: a flexible substrate configured to display an image; a first layer formed over a first surface of the flexible substrate and configured to compress horizontally with a compressive strain force; and an adhesive interposed between the flexible substrate and the first layer.

In the above flexible display panel, the adhesive is configured to attach the first layer to the first surface of the flexible substrate.

The above flexible display panel further comprises a polarizing film formed over a second surface of the flexible substrate.

In the above flexible display panel, the flexible substrate and first layer are bendable towards the polarizing film.

The above flexible display panel further comprises a protective film formed over the first surface of the flexible substrate and configured to block moisture transmission, wherein the first layer is disposed between the flexible substrate and the protective film.

In the above flexible display panel, the flexible substrate has a portion of the first surface folded or bent in a direction facing the remaining portion of the first surface.

Another aspect is a method for manufacturing a flexible display panel comprising: forming a first layer; coating an adhesive on a first surface of the first layer; and providing a flexible substrate having first and second surfaces on the adhesive, wherein the first surface and the second surface face each other, wherein the first layer is configured to compress horizontally with a compressive strain force.

The above method further comprises providing a polarizing film on the second surface of the flexible substrate.

In the above method, the first layer is attached to the first surface of the flexible substrate by the adhesive in a tensioned state by a tensile force.

In the above method, the first layer is attached to the first surface of the flexible substrate by the adhesive in a heated and expanded state.

In the above method, the flexible substrate is configured to display an image through the first surface of the flexible substrate.

In the above method, the flexible substrate has a portion of the first surface that is folded or bends in a direction facing a remaining portion of the first surface.

The above method further comprises stretching the first layer such that the stretched first layer has a predetermined tensile force.

In the above method, the tensile force and the compressive strain force apply in opposite directions.

The above method further comprises heating the first layer such that the first layer expands, before coating the adhesive on the first surface of the first layer.

Another aspect is a flexible display panel, comprising: a flexible substrate configured to display an image; a first layer formed over a first surface of the flexible substrate and configured to compress horizontally; a protective film formed over the first surface of the flexible substrate and configured to block moisture transmission; a first adhesive layer interposed between the protective film and the first layer; and a second adhesive layer interposed between the first layer and the flexible substrate.

In the above flexible display panel, the flexible substrate has a substantially uniform thickness throughout the flexible display panel, wherein the first layer has a substantially uniform thickness throughout the flexible display panel.

In the above flexible display panel, the flexible substrate and the first layer are bendable towards the polarizing film.

The above flexible display panel further comprises a polarizing film formed over a second surface of the flexible substrate, wherein the first and second surfaces of the flexible substrate oppose to each other.

### BRIEF DESCRIPTION OF THE DRAWINGS

Example embodiments will now be described more fully hereinafter with reference to the accompanying drawings; however, they can be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions can be exaggerated for clarity of illustration. It will be understood that when an element is referred to as being “between” two elements, it can be the only element between the two elements, or one or more intervening elements can also be present. Like reference numerals refer to like elements throughout.

FIG. 1 is a cross sectional view schematically illustrating a flexible display panel according to an embodiment.

FIGS. 2A, 2B and 2C are cross sectional views illustrating a method of manufacturing a flexible display panel according to an embodiment.

FIG. 3 is a concept diagram for illustrating strain rate of a flexible display depending on the bending of the flexible display panel as shown in FIG. 1.

FIG. 4 is a graph illustrating a state of a flexible display panel due to the strain rate of a flexible substrate according to an embodiment.

FIGS. 5A and 5B are cross sectional views illustrating a method of manufacturing a flexible display panel according to another embodiment.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments can be modified in various different ways, all without departing from the spirit or scope of the described technology. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or intervening elements or layers can be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the described technology.

Spatially relative terms, such as “beneath”, “below”, “lower”, “above”, “upper” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

The terminology used herein is for the purpose of describing particular embodiments only and is not intended to be limiting of the described technology. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

FIG. 1 is a cross sectional view schematically illustrating a flexible display panel according to an embodiment.

Referring to FIG. 1, a flexible display panel 10 according to an embodiment includes a flexible substrate 120, a polarizing film 110, an adhesive 130 and a first layer 140.

The flexible substrate 120 can display images and include a first surface and a second surface, the first surface and the second surface facing each other. The flexible substrate 120 can include a base substrate and a pixel provided on the base substrate and displaying images. The image can be displayed through either the first surface or the second surface. In an embodiment, image being displayed through the second surface is described as an example.

The base substrate can be any one of a film or a plastic substrate including high molecular organic matter having flexible property.

For example, but without limitation thereto, the base substrate is formed of any one of polyethersulfone (PES), polyacrylate, polyetherimide (PEI), polyethyelenen naphthalate (PEN), polyethylene terephthalate (PET), polyphenylene sulfide (PPS), polyarylate (PAR), polyimide (PI), polycarbonate (PC), cellulose triacetate (TAC), polynorbornene, or cellulose acetate propionate (CAP).

The pixel, though not illustrated, can include a wire, a thin film transistor coupled to the wire, an electrode switched by the thin film transistor, and an image display layer controlled by the electrode.

The wire can include a plurality of gate lines and a plurality of data lines crossing the gate lines.

The thin film transistor can be provided in plurality such that passive matrix driving or active matrix driving can be implemented. If the thin film transistor is provided to an active matrix, the thin film transistor can be provided in plurality, each of which can be coupled to an applicable gate line among the gate lines and an applicable data line among the data lines.

The electrode can be provided in a plurality and be coupled to each thin film transistor.

Although not illustrated, the thin film transistor can include a gate electrode, an active layer, a source electrode and a drain electrode. The gate electrode can branch off from a corresponding gate line among the gate lines. The active layer can be insulated from the gate electrode. On the active layer, the source electrode and the drain electrode can be distanced apart from each other such that the active layer can be exposed. The source electrode can branch off from a corresponding data line from the data lines.

The image display layer can include a liquid crystal layer, an electrophoretic layer, an electrical wettable layer, an organic light emitting layer, and the like. The image display layer can be driven corresponding to a voltage applied to the electrode(s).

A polarizing film 110 can be formed on a second surface of the flexible substrate 120 and prevent image quality from being deteriorated due to reflection of incident light from outside.

The polarizing film 110 can be attached to the second surface of the flexible substrate 120, completely closely attached, without any portion raised or unattached, and can be formed of at least one layer having polarization property. For example, but without limitation thereto, the polarizing film 110 is a film having a circular polarizing layer.

The adhesive 130 can be formed on the first surface of the flexible substrate 120 and attach a first layer 140 on the first surface of the flexible substrate 120. The adhesive 130 can be formed of any one of an organic insulating material or a high molecular material having adhesive property. For example, the adhesive 130 includes a pressure sensitive adhesive (PSA), but it is not limited thereto.

The first layer 140 can be formed on the first surface of the flexible substrate 120 and can be attached on the first surface of the flexible substrate 120 by the adhesive 130. The first layer 140 can be include a protective film having barrier property, blocking humidity or moisture inflow from outside.

For example, but without limitation thereto, the first layer 140 including a single layer or multi layers, is formed of an inorganic matter (e.g., silicon oxide (SiOx), silicon nitride (SiNx), silicon oxynitride (SiON), aluminum oxide (AlO), aluminum nitride (AlON), and the like) being coated on an organic matter (acryl, polyimide (PI), polyester, and the like) in film form, but it is not limited thereto.

The first layer 140 can have compressive strain and can affect strain due to bending movement of the flexible substrate 120 due to the compressive strain.

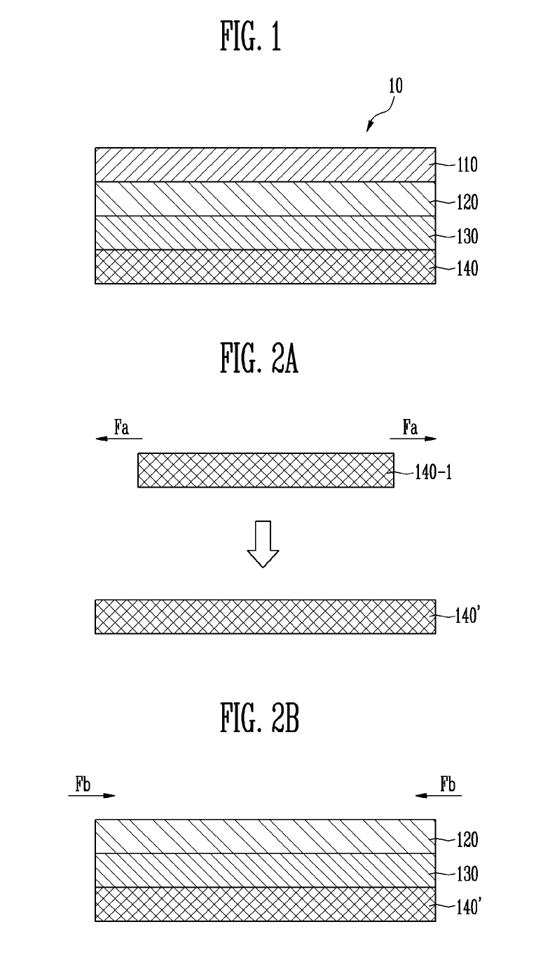

FIGS. 2A, 2B and 2C are cross sectional views illustrating a method of manufacturing a flexible display panel according to an embodiment.

Referring to FIG. 2A, a first layer 140-1 prior to transformation for forming a first layer 140′ can be prepared. The first layer 140-1 prior to transformation can change in shape depending on external force or environmental conditions.

In an embodiment, if the first layer 140-1 before transformation is applied a tensile force Fa in a horizontal direction on a first surface from outside, the first layer 140-1 before transformation a tensile force Fa is applied in the downward direction. For convenience of illustration, a method of applying the tensile force Fa in a horizontal direction on the first surface of the first layer 140-1 before transformation is described. However, the direction in which a tensile force is applied to the first layer 140-1 before transformation can change in a variety of ways.

For the tensioned first layer 140′, a compressive strain can occur in a direction opposite to the tensile force Fa. A tensile force can be continuously applied to the first layer 140′ such that the first layer 140′ is not constricted according to the compressive strain as generated.

In another embodiment, if the first layer 140-1 before transformation is implemented with a material sensitive to temperature change, the first layer 140-1 before transformation can be constricted or expand depending on the surrounding temperature. The strain of the first layer 140-1 in terms of expansion or constriction can be adjusted by adjustment in temperature. For example, the first layer 140-1 before transformation is heated using a hot plate.

Once the first layer 140-1 before transformation is heated and expands, the first layer 140′ can be continuously heated in order that the expanded first layer 140′ does not change in shape again according to the surrounding temperature change.

The first layer 140-1 before transformation can be heated in a state in which the adhesive 130 is coated on one surface. The first layer 140-1 before transformation and the adhesive 130 can concurrently expand, and a degree of expansion can differ for each.

Referring to FIG. 2B, the first layer 140′ is stacked on the first surface of the flexible substrate 120 in a state in which it is tensioned or expanded.

The adhesive 130 can be coated on one surface of the first layer 140′. For example, but without limitation thereto, the adhesive 130 is sprayed on one surface of the first layer 140′ such that the adhesive 130 can have substantially uniform thickness. The adhesive 130 having substantially uniform thickness on one surface of the first layer 140′ can be attached on the first surface of the flexible substrate 120.

After the adhesive 130 and the flexible substrate 120 are stacked on one surface of the first layer 140′, the first layer 140′ can change in shape according to external force or environment conditions being applied.

In an embodiment, if the tensile force Fa applied to the first layer 140′ is removed, the first layer 140′ has a compressive strain Fb to return to the shape of the first layer 140-1 before transformation.

In another embodiment, if the first layer 140′ that is heated and expanded is cooled down, the first layer 140′ has the compressive strain Fb to return to the shape of the first layer 140-1 before transformation.

Referring to FIG. 2C, the adhesive 130, the flexible substrate 120 and the polarizing film 110 are stacked on one surface of the first layer 140′.

The polarizing film 110 can be attached on the second surface of the flexible substrate 120 that is affected by the compressive strain Fb by the first layer 140′. The polarizing film 110 can prevent image quality from being deteriorated by the reflection of the incident light into the flexible substrate 120.

In an embodiment, for convenience of illustration, it is described that the external force or environment conditions provided to the first layer 140′ changed after the adhesive 130 and the flexible substrate 120 are stacked on one surface of the first layer 140′. However, depending on various embodiments, the external force or environment conditions provided to the first layer 140′ after the adhesive 130, the flexible substrate 120, and the polarizing film 110 are stacked on one surface of the first layer 140′ can change. Therefore, the compressive strain Fb occurring due to the first layer 140′ can affect the adhesive 130, the flexible substrate 120 and the polarizing film 110.

FIG. 3 is a concept diagram for illustrating strain rate of a flexible display depending on the bending of the flexible display panel as shown in FIG. 1.

Referring to FIGS. 1 to 3, a flexible display panel 10 includes a polarizing film 110, a flexible substrate 120, an adhesive 130 and a first layer 140′.

In an embodiment, if bending occurs as an external force acts on the flexible display panel 10, a compressive strain Fc occurs for the flexible display panel 10 to return to the state before the bending occurred. The compressive strain Fc can be a power which includes a compressive strain occurring according to a property of the material for the flexible display panel 10 and the compressive strain Fb generated by the constriction of the first layer 140′.

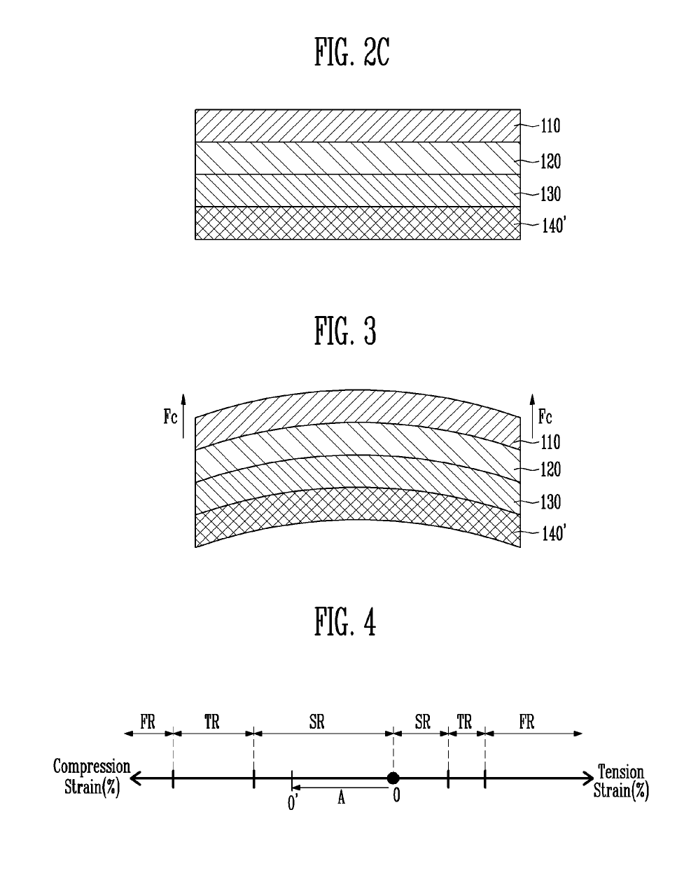

Therefore, the flexible display panel 10 can expand a range of flexibility according to the bending due to the compressive strain Fc occurring by including the compressive strain Fb. A detailed description thereon is provided with reference to FIG. 4.

FIG. 4 is a graph illustrating a state of a flexible display panel due to the strain rate of a flexible substrate according to an embodiment.

Referring to FIG. 4, the graph includes a compression strain on a left side and a tension strain on a right side based on zero point.

The compression strain shows a transformation state occurring by applying a compressive force to the flexible substrate 120, and the tension strain illustrates a transformation state occurring by applying a tensile force to the flexible substrate 120. For example, but without limitation thereto, if the tension strain is about 0.2%, transformation occurs by applying the tensile force to the flexible substrate 120, and the flexible substrate 120 after transformation, rather than the flexible substrate 120 before transformation, can be changed as much as about 0.2%.

A safety region SR can be a section that includes a strain that does not have a crack or a defect of in a panel when a compressive force or tensile force is applied to the flexible substrate 120.

A transformation region TR can be a section that includes a strain that can have crack or transformation of the panel when a compressive force or tensile force is applied to the flexible substrate 120.

A fracture region FR is a section that includes a strain that has a crack or damage to the panel occurring when the compressive force or tensile force is applied to the flexible substrate 120.

In an embodiment, the flexible substrate 120 is affected by a compressive strain generated from the first layer. Therefore, the zero point of the strain regarding the flexible display panel 10 can be moved through the already generated compressive strain Fb. That is, the flexible display panel can have a zero point (0′) of strain which moves as much as A %.

The flexible display panel 10, which includes the zero point (0′) of the moved strain, can include a safety region having a narrow width with respect to the compression strain but can include a safety region having a relatively wide width with respect to the tension strain.

The flexible display panel can offset a preset portion due to the compressive strain Fb generated from inside even though a tensile force which is stronger is applied. Accordingly, the flexible display panel can include a rather wide flexibility scope tensioned by tensile force due to the compressive strain Fb.

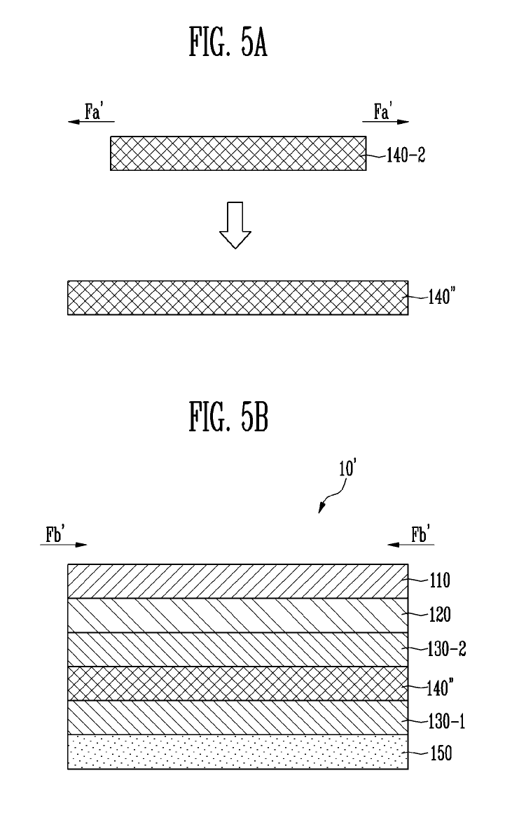

FIGS. 5A and 5B are cross sectional views illustrating a method of manufacturing a flexible display panel according to another embodiment.

Referring to FIG. 5A, a first layer 140-2 before transformation changes in shape depending on an external force or environmental condition.

In an embodiment, the first layer 140-2 includes an elastic layer, e.g., including the property of being implemented as an elastomer, tensioned due to an external force, and returning to an original shape if the external force is removed.

In an embodiment, the first layer 140-2 before transformation is applied a tensile force Fa′, similar to the first layer 140-1 before transformation, and be tensioned to a first layer 140″ or expand to the first layer 140″ depending on the temperature change.

The first layer 140-2 before transformation and the first layer 140-1 before transformation can have different properties of material. However, The shape of both layers 140-1 and 140-2 can change depending on an external force or environmental condition in a similar way, and thus, repetitive description will be omitted.

Referring to FIGS. 5A and 5B, a flexible display panel 10′ includes a polarizing film 110, a flexible substrate 120, adhesives 130-1 and 130-2, a first layer 140″ and a protective film 150.

The first adhesive 130-1, the first layer 140″, the second adhesive 130-2, the flexible substrate 120 and the polarizing film 110 can be sequentially stacked on one surface of the protective film 150.

The polarizing film 110, the flexible substrate 120, and the adhesives 130-1 and 130-2 respectively have substantially the same features as the polarizing film 110, the flexible substrate 120, and the adhesive 130 in FIG. 1, and thus, repetitive description will be omitted.

The protective film 150 can be implemented with a protective film having a barrier property blocking humidity or moisture introduction from outside.

For example, but without limitation thereto, the protective film 150, as a single layer or multi layers, is formed of an inorganic matter (e.g., silicon oxide (SiOx), silicon nitride (SiNx), silicon oxynitride (SiON), aluminum oxide (AlO), aluminum nitride (AlON), and the like) being coated on an organic matter (acryl, polyimide (PI), polyester, and the like) in film form, but it is not limited thereto.

The first layer 140″ can be stacked on a first surface of the flexible substrate 120 in a tensioned or expanded state.

A first adhesive 130-1 can be coated on one surface of the protective film 150. For example, but without limitation thereto, the first adhesive 130-1 is sprayed on one surface of the protective film 150 such that the adhesive 130-1 can have a substantially uniform thickness. The adhesive 130-1 having the substantially uniform thickness on one surface of the protective film 150 can be attached on one surface of the first layer 140″.

That is, the first adhesive 130-1 can be formed between the protective film 150 and the first layer 140″. The protective film 150 and the first layer 140″ can be attached with the first adhesive 130-1.

After the first adhesive 130-1 and the first layer 140″ are stacked on one surface of the protective film 150, the first layer 140″ can change in shape depending on an external force or environmental condition being applied.

In an embodiment, if the tensile force Fa′ applied to the first layer 140″ is removed, the first layer 140″ changes in shape due to a compressive strain Fb′ for returning to the shape of the first layer 140-2 before transformation.

In another embodiment, if the heated and expanded first layer 140″ is cooled down, the first layer 140″ can change in shape due to the compressive strain Fb′ for returning to the shape of the first layer 140-2 before transformation.

A second adhesive 130-2, a flexible substrate 120 and a polarizing film 110 can be stacked on one surface of the first layer 140″.

The second adhesive 130-2 can be coated on one surface of the first layer. For example, but without limitation thereto, the second adhesive 130-2 is sprayed on one surface of the first layer 140″ such that the second adhesive 130-2 can have a substantially uniform thickness. The second adhesive 130-2 having substantially uniform thickness on one surface of the first layer 140″ can be attached on the first surface of the flexible substrate 120, and the polarizing film 110 can be attached on the second surface of the flexible substrate 120.

The compressive strain Fb′ occurring due to the first layer 140″ can affect the strain of the flexible substrate 120. In an embodiment, the flexible display panel 10′ has zero point of transformation ratio moving as shown in graph FIG. 3.

The inventive technology has been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the present invention as set forth in the following claims.

What is claimed is:

1. A flexible display panel, comprising:
a flexible substrate configured to display an image;
a first layer formed over a first surface of the flexible substrate and configured to compress horizontally with a compressive strain force; and
an adhesive interposed between the flexible substrate and the first layer.

2. The flexible display panel as claimed in claim 1, wherein the adhesive is configured to attach the first layer to the first surface of the flexible substrate.

3. The flexible display panel as claimed in claim 1, further comprising a polarizing film formed over a second surface of the flexible substrate.

4. The flexible display as claimed in claim 3, wherein the flexible substrate and first layer are bendable towards the polarizing film.

5. The flexible display panel as claimed in claim 1, further comprising a protective film formed over the first surface of the flexible substrate and configured to block moisture transmission,
wherein the first layer is disposed between the flexible substrate and the protective film.

6. The flexible display panel as claimed in claim 1, wherein the flexible substrate has a portion of the first surface folded or bent in a direction facing the remaining portion of the first surface.

7. A method for manufacturing a flexible display panel comprising:
forming a first layer;
coating an adhesive on a first surface of the first layer; and
providing a flexible substrate having first and second surfaces on the adhesive, wherein the first surface and the second surface face each other,
wherein the first layer is configured to compress horizontally with a compressive strain force.

8. The method as claimed in claim 7, further comprising providing a polarizing film on the second surface of the flexible substrate.

9. The method as claimed in claim 7, wherein the first layer is attached to the first surface of the flexible substrate by the adhesive in a tensioned state by a tensile force.

10. The method as claimed in claim 7, wherein the first layer is attached to the first surface of the flexible substrate by the adhesive in a heated and expanded state.

11. The method as claimed in claim 7, wherein the flexible substrate is configured to display an image through the first surface of the flexible substrate.

12. The method as claimed in claim 7, wherein the flexible substrate has a portion of the first surface that is folded or bends in a direction facing a remaining portion of the first surface.

13. The method as claimed in claim 7, further comprising stretching the first layer such that the stretched first layer has a predetermined tensile force.

14. The method as claimed in claim 13, wherein the tensile force and the compressive strain force apply in opposite directions.

15. The method as claimed in claim 7, further comprising heating the first layer such that the first layer expands, before coating the adhesive on the first surface of the first layer.

16. A flexible display panel, comprising:
a flexible substrate configured to display an image;
a first layer formed over a first surface of the flexible substrate and configured to compress horizontally;
a protective film formed over the first surface of the flexible substrate and configured to block moisture transmission;
a first adhesive layer interposed between the protective film and the first layer; and
a second adhesive layer interposed between the first layer and the flexible substrate.

17. The flexible display panel as claimed in claim 16, wherein the flexible substrate has a substantially uniform thickness throughout the flexible display panel, and wherein the first layer has a substantially uniform thickness throughout the flexible display panel.

18. The flexible display panel as claimed in claim 17, wherein the flexible substrate and the first layer are bendable towards the polarizing film.

19. The flexible display panel as claimed in claim 18, further comprising a polarizing film formed over a second surface of the flexible substrate, wherein the first and second surfaces of the flexible substrate oppose to each other.
